(19) United States
(12) Patent Application Publication
(10) Pub. No.: US 2023/0195137 A1
(43) Pub. Date: Jun. 22, 2023

(54) Methods for Robotic Office Management

(71) Applicants: Marc Lemchen, New York, NY (US); Todd Blankenbecler, Atlanta, GA (US)

(72) Inventors: Marc Lemchen, New York, NY (US); Todd Blankenbecler, Atlanta, GA (US)

(21) Appl. No.: 18/083,103

(22) Filed: Dec. 16, 2022

Related U.S. Application Data
(60) Provisional application No. 63/291,764, filed on Dec. 20, 2021.

(51) Int. Cl. G05D 1/02; G06V 40/16; B25J 11/00; G06Q 10/0631

(52) U.S. Cl. CPC G05D 1/0287; G06V 40/172; B25J 11/008; G06Q 10/06316; G05D 2201/0211

(57) ABSTRACT

A method for managing an office using a network of robotic elements. The method includes transmitting a first signal corresponding to a request to at least one robotic element within the network of robotic elements, wherein the request comprises a first location and a first task to be completed at the first location. The robotic element then navigates to the first location associated with the request and performs the first task that is associated with the request. The robotic element then transmits a second signal which corresponds to the request by the at least one robotic element to the network of robotic elements, wherein the second signal corresponding to the request comprises a notification that the first task has been performed. The robotic element may be an airborne drone or a wheeled robot. Each robotic element may perform several tasks associated with office management.

This application claims priority to, and the benefit of the earlier filing date of US provisional patent application entitled “System and Method for Robotic Office Management”, filed on Dec. 20, 2021, Ser. No. 63/291,764, pursuant to 35 USC 119, the contents of all of which are incorporated herein by reference.

### BACKGROUND

### Field of the Technology

The invention relates to the field of robotic office management, specifically a network of robotic elements which cooperate to efficiently assist in maintaining, running, and managing an office space, including but not limited to offices for doctors, dentists, and orthodontists.

### Description of the Prior Art

Robots and robotic devices, once the thing of science fiction, are increasingly becoming more and more common throughout society. Initially starting in factories and warehouses, robotic assistants and the like have started becoming more popular within an individual's home or business. Vacuums, home security systems, kitchen appliances, and a whole host of other items have been enhanced through robotics if not completely overtaken by them.

One particular field which is increasingly under the influence of robotics is that of general office management. Typically, robots used for personal assistance or office management consist of a wheeled device that has a screen or other means of user interaction mounted or disposed in a top portion of the device, thereby simulating a “head” or “face.” Using a camera or other sensor means, the robot may navigate about an interior space using a plurality of waypoints or tags which mark a path for the robot to follow. Some personal robots have the ability to form a map of the geographic location they are in by either running through a tutorial with the operator/user or by incrementally building a map through gradual and systematic probing using a plurality of proximity or motion sensors. Alternatively, the robot may be controlled remotely by an operator who views the surrounding area through the robot's camera and who may then send commands accordingly through a controller, cell phone, or other smart device.

Regardless of how it is controlled or how it moves through the environment however, office management assistant robots traditionally have played relatively minor roles. For example, some only serve to fulfill drug prescriptions (U.S. Pat. No. 9,043,012) or manage or track an inventory (U.S. Pat. No. 7,693,757), while others may find or track a patient within a 3D space in order to provide the patient with a means of communicating with a third party or otherwise interact with the patient (U.S. Application Publication 2007/0192910). Still other personal/office management robots use artificial intelligence to identify a specific patient and then dispense a medication which corresponds to that patient while also monitoring the patient for any adverse side effects (U.S. Application Publication 2020/0411154).

What is missing from the prior art however is a true robotic office management system or network that is specifically designed for a medical, dental, or orthodontic practice among others. What is needed is a plurality of robots or robotic elements which cooperate to form a comprehensive patient management system. The system should comprise more than one type of robot in order to perform multiple different tasks including but not limited to checking in or registering patients arriving at the office, escorting the patients to a designated location within the office, assisting the office professionals within the office, and transporting equipment or other items from one location in the office to another. The system should be largely autonomous and easy to customize or configure for each type of business or office setting the system is deployed in.

### BRIEF SUMMARY

The current invention provides a method for managing an office using a network of robotic elements. The method includes transmitting a first signal corresponding to a request to at least one robotic element within the network of robotic elements, wherein the request comprises a first location and a first task to be completed at the first location. The robotic element then navigates to the first location associated with the request and performs the first task that is associated with the request. The robotic element then transmits a second signal which corresponds to the request by the at least one robotic element to the network of robotic elements, wherein the second signal corresponding to the request comprises a notification that the first task has been performed.

In one embodiment, transmitting the first signal corresponding to the request to at least one robotic element within the network of robotic elements comprises transmitting the first signal corresponding to the request from a control point that is wirelessly connected to the robotic element within the network of robotic elements. In this embodiment, the first request may be initiated at a computer or smart device and then transmitted from the computer or smart device to the control point.

In other embodiments, transmitting the first signal corresponding to the request to the robotic element within the network of robotic elements specifically includes transmitting the first signal corresponding to the request to at least one airborne robotic element within the network of robotic elements, or alternatively, transmitting the first signal corresponding to the request to at least one wheeled robotic element within the network of robotic elements.

In another embodiment, performing the first task associated with the request by the robotic element specifically includes scanning a first individual within the office by the robotic element, determining if the scanned first individual matches a preexisting credential associated with a patient. A second individual is scanned within the office by the robotic element if the scanned first individual does not match the preexisting credential associated with the patient, or alternatively, the scanned first individual is escorted to a second location if the scanned first individual does match the preexisting credential associated with the patient. Here, scanning the first individual within the office by the robotic element may include performing a facial recognition scan of the first individual by the robotic element, and then determining if the scanned first individual matches the preexisting credential associated with the patient by matching a face of the scanned first individual with a preexisting image of the patient. Alternatively, scanning the first individual within the office by the at least one robotic element may include performing a scan of an RFID chip disposed on the first individual by the robotic element, and then determining if the scanned first individual matches the preexisting credential associated with the patient by matching a reading from the RFID chip disposed on the scanned first individual with a preexisting ID associated with the patient. In this embodiment, escorting the scanned first individual to the second location if the scanned first individual does match the preexisting credential associated with the patient may also include confirming that the first individual is the same as the patient by the at least one robotic element.

In one embodiment, performing the first task associated with the request by the robotic element specifically includes acquiring an item associated with the request at the first location by the robotic element, navigating to a second location associated with the request by the robotic element, and then delivering the item at the second location by the robotic element. In this embodiment, acquiring the item associated with the request at the first location may specifically include picking up the item by the robotic element at the first location, or alternatively, coupling the item to the robotic element by a user at the first location.

In certain embodiments, the method also includes returning to the first location by the robotic element if a second signal corresponding to the request is transmitted to the robotic element, or alternatively, navigating to a charging station by the robotic element if no second signal corresponding to the request is transmitted to the robotic element.

In another embodiment, performing the first task associated with the request by the at least one robotic element specifically includes providing a user with an item disposed on the robotic element, remaining at the first location by the robotic element until the user has returned the item to the robotic element, and then exiting the first location by the robotic element. Here, this embodiment may further include returning to the first location by the robotic element, or alternatively, navigating to a sanitization station by the robotic element.

The invention also provides a method for managing an office using a network of robotic elements. The method includes transmitting a first signal corresponding to a first request to a first plurality of robotic elements within the network of robotic elements, wherein the first request comprises a first location and a first task to be completed at the first location and transmitting a second signal corresponding to a second request to a second plurality of robotic elements within the network of robotic elements, wherein the second request comprises a second location and a second task to be completed at the second location. Next, at least one of the first plurality of robotic elements navigates to the first location associated with the first request while at least one of the second plurality of robotic elements navigates to the second location associated with the second request. The first task associated with the first request and the second task associated with the second request are then performed by the at least one of the first plurality of robotic elements and the at least one of the second plurality of robotic elements, respectively.

In one embodiment, transmitting the first signal corresponding to the first request to the first plurality of robotic elements within the network of robotic elements and transmitting the second signal corresponding to the second request to the second plurality of robotic elements within the network of robotic elements each may specifically include transmitting the first and second signals corresponding to the first and second requests from a control point that is wirelessly connected to the first and second plurality of robotic elements. Additionally, the method may also include initiating the first and second request at a computer or smart device and then transmitting the initiated first and second request from the computer or smart device to the control point. Alternatively, initiating the first and second request at a computer or smart device also includes initiating a list comprising a plurality of tasks to be performed by the first and second plurality of robotic elements.

In another embodiment, transmitting the first signal corresponding to the first request to the first plurality of robotic elements within the network of robotic elements and transmitting the second signal corresponding to the second request to the second plurality of robotic elements within the network of robotic elements specifically includes transmitting the first signal corresponding to the first request to at least one airborne robotic element within the first plurality of robotic elements, while also transmitting the second signal corresponding to the second request to at least one wheeled robotic element within the second plurality of robotic elements.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is an illustration depicting a network of robotic elements connected to a control point that is managed and controlled by the method of the current invention.

FIG. 2 is a flow chart illustrating a method of the current invention where robotic elements are used to identify and escort a patient from a waiting room to an available examination room or chair.

FIG. 3 is a flow chart illustrating an alternative embodiment of the current invention where robotic elements are used to transport items or objects from a first location to a second location.

FIG. 4 is a flow chart illustrating an alternative embodiment of the current invention where robotic elements are used to assist a user during a medical procedure.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

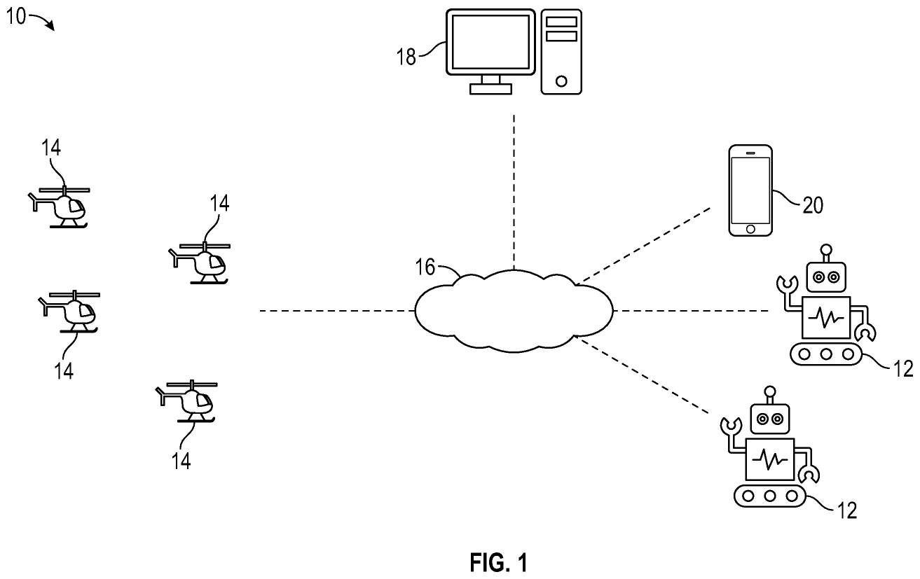

Turning to FIG. 1 and the general concept of the current invention, the robotic office management system 10 comprises a plurality of robots 12, 14 that are interconnected or communicated to a central control point or server 16. Also connected or communicated to the control point or server 16 is a user computer or terminal 18. The user computer or terminal 18 may be a traditional personal computer or laptop as is known in the art, or alternatively, may be a smart phone or other smart device 20. The control point or server 16 likewise may be a personal computing device which may be disposed within the same physical location as the user computer or terminal 18 or alternatively, may be a central processing unit and user interface which exists completely on a network such as the internet or other cloud network. In an alternative embodiment, the user computer or terminal 18 and the control point or server 16 may be the same physical component with the control point or server 16 being disposed within the user computer or terminal 18 itself.

Each of the plurality of robots 12, 14 comprise means for wirelessly receiving and transmitting signals and data to and from the control point or server 16 using Wi-Fi, Bluetooth®, or other equivalent means. Additionally, each robot 12, 14 comprises a GPS unit, a RFID chip, or other identification or tracking means so that the control point or server 16 may track and monitor the current location and status for each robot 12, 14 in real time. A user may view the current location and status of any or all of the robots 12, 14 through the display of the user computer or terminal 18 or through the display of their smart device 20.

A first plurality of robots 12 within the system are a plurality of grounded or wheeled robots which traverse through the office space using one or more wheels, casters, tracks, or the like. Each wheeled robot 12 comprises a suite of sensors and at least one camera communicated to a processing unit so that the wheeled robot 12 is capable of monitoring a 3D space and traversing through the 3D space while avoiding unwanted contact with patients, other robots, or any other object. The wheeled robot 12, using artificial intelligence and/or a custom designed software program stored within an internal memory is specifically able to generate a map of the interior office space and arcuately place their own position within that space. Alternatively, the map of the interior space may be given to the wheeled robot 12 either directly by a user or by downloading it from the central control point or server 16. Additionally, each wheeled robot 12 comprises a screen, a user interface, or other display means which serves to communicate, interact, or otherwise provide a direct input means with the patients or office staff as needed. Additional means for communicating with a patient, office staff, or other robot including but not limited to lights, speakers, microphones, wireless antennas, or other equivalent means may disposed on or within each wheeled robot 12 so as to facilitate communication and to ensure that the specified task delegated to that specific wheeled robot 12 is properly performed.

A second plurality of robots 14 within the system are a plurality of airborne robots or drones which traverse through the office space using one or more propellers, fans, or the like. Each airborne robot 14 comprises a suite of sensors and at least one camera communicated to a processing unit so that the airborne robot 14 is capable of monitoring a 3D space and traversing through the 3D space while avoiding unwanted contact with patients, other robots, or any other object. The airborne robot 14, using artificial intelligence and/or a custom designed software program stored within an internal memory is specifically able to generate a map of the interior office space and arcuately place their own position within that space. Alternatively, the map of the interior space may be given to the airborne robot 14 either directly by a user or by downloading it from the central control point or server 16. Additionally, each airborne robot 14 may comprise a screen, a user interface, or other display means which serves to communicate, interact, or otherwise provide a direct input means with the patients or office staff as needed. Additional means for communicating with a patient, office staff, or other robot including but not limited to lights, speakers, microphones, wireless antennas, or other equivalent means may disposed on or within each airborne robot 14 so as to facilitate communication and ensure that the specified task delegated to that specific airborne robot 14 is properly performed.

The plurality of wheeled robots 12 and the plurality of airborne robots 14 together with the control point or server 16 cooperate to efficiently manage and assist human workers or employees in running an office or other business. In effect, each of the plurality of robots 12, 14 performs a specific set of tasks that are traditionally or previously performed by receptionists, office managers, or other assistants, thereby freeing those workers to perform more critical tasks. Each robot 12, 14 receives its instructions from either the control point or server 16 or from a user/office worker directly who may send instructions or request assistance through the control point or server 16 using either the user computer or terminal 18 or a smart device 20.

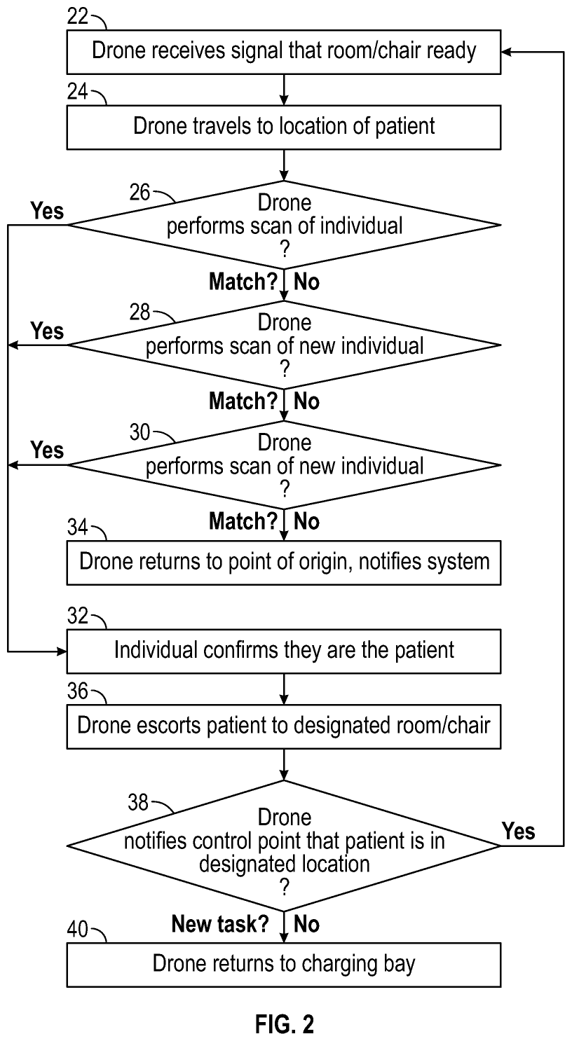

In one particular embodiment seen in FIG. 2, each airborne robot or drone 14 is used to notify a patient currently in a waiting room that a specific examination room or dental chair is ready. Specifically, upon receiving a signal from either the control point or server 16, user computer or terminal 18, or a smart device 20 that a particular examination room or chair is available for a specified patient in step 22, an airborne robot 14 is activated and sent into the waiting room where the specified patient is located in step 24. Upon entering the waiting room, the airborne robot 14 uses its camera and associated AI software to scan a first individual in the room at step 26. If the first individual does not match the specified patient as determined by the associated AI software, the drone 14 begins scanning a new individual in step 28. The drone will repeatedly scan a new individual in step 30 until a match is made between a pre-existing image or data set corresponding to the specified patient and the current incoming image data of the specified patient. Alternatively, instead of moving about the waiting room scanning each individual, the airborne robot 14 may move to designated spot within the room and then switch to a stationary or hover mode in order make an audio and/or visual announcement that the specified patient present themselves to the camera of the airborne robot 14. When the specified person stands in front of the airborne robot 14, it may then scan and perform a facial recognition program as discussed above. In an alternative embodiment, each patient may be issued an RFID tag or name badge to hold or wear while they wait for their appointment in the waiting room. Upon entering the waiting room, instead of scanning the face of each patient using facial recognition software, the airborne robot 14 may scan each RFID tag or name badge with an RFID reader until the corresponding patient matching a provided identification has been found. If after scanning all the available individuals within a waiting room and no match has been determined, the drone 14 in step 34 will return to its point of origin and notify the control point or server 16, the user computer or terminal 18, or the smart device 20 that the specified patient could not be located, thereby prompting a human user to check the waiting room manually.

If, however a match is determined between the specified patient and the individual identified by the drone 14, the drone 14 may request additional confirmation in step 32 that the person currently being viewed is in fact the same person as the specified patient dictated by the control point or server 16. This may be done by the individual making a manual confirmation on a screen carried by or disposed on the airborne robot 14, or by simply nodding after receiving a visual or audio prompt, the AI software contained within the airborne robot 14 being trained to detect when a physical movement by the patient is a nod or other form of assent.

After confirming that the individual being scanned is in fact the same person as the specified patient, the airborne robot 14 may then lead or escort the patient to the previously designated examination room or chair in step 36 by navigating the office space using the pre-generated map stored within either the control point or server 16 and/or the airborne robot 14 itself. When the specified patient has entered the designed examination room or has sat down within the designated examination chair, the AI image software recognizes it as such and notifies the control point or server 16, user computer or terminal 18, or the smart device 20 in step 38 that the specified patient has been successfully escorted and that the task is complete. The airborne robot 14 may then receive another task from the control point or server 16 and then repeat the entire process beginning at step 22, or alternatively return to a centrally located rack, base unit, or charging bay in step 40. In one embodiment, the airborne robot 14 may emit a corresponding audio or visual signal or cue via a speaker, screen, light, or other audio or visual means to indicate that it is waiting for the specified patient, escorting the patient, or is making its way back to the base unit or charging bay during steps 26, 36, and 40, respectively.

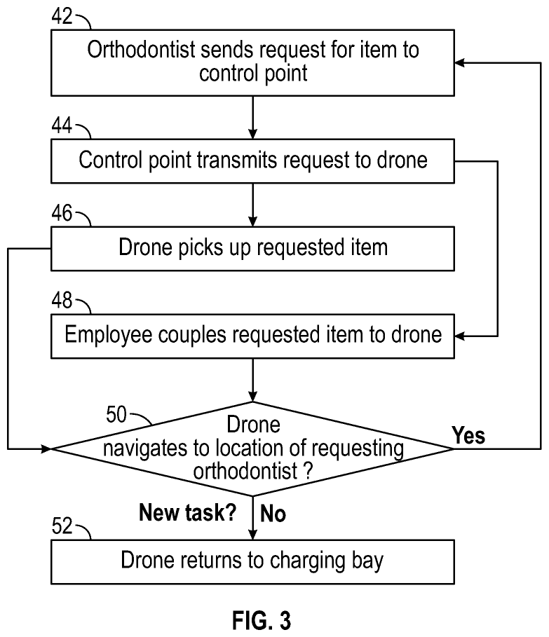

In another embodiment seen in FIG. 3, the method of the current invention provides that each airborne robot or drone 14 may be used to transport or move small or lightweight items or materials from one location within the office to another. In this embodiment, the airborne robot 14 comprises a tray, shelf, hook, articulated clamps, or other means for holding, gripping, or otherwise maintaining a small item thereon. In one example, if an orthodontist requires a retainer for a patient they are currently seeing, the orthodontist may transmit a request via a smart device 20 or the user computer or terminal 18 to the control point or server 16 that an airborne robot 14 bring over or transport the corresponding retainer in step 42. The control point or server 16 then relays the instructions to the appropriate airborne robot 14 in step 44. The airborne robot 14 may find the retainer from a designated location such as a supply rack or closet in step 46, or alternatively in step 48, an office worker or other employee may couple or attach the requested retainer directly to the airborne robot 14. Regardless of how the airborne robot 14 receives the requested item, in step 50 the airborne robot 14 then navigates to the examination room or chair that the orthodontist sent the request from and either deposits the retainer to a designated location or switches to a hover mode so as to allow the orthodontist to remove or detach the retainer from the airborne robot 14. Once the retainer has been removed, the airborne robot 14 is then free to either perform another task and thus repeat the entire process or to return its base unit and/or charging bay in step 52.

It is to be expressly understood that in a further embodiment, any one of the plurality of wheeled robots 12 may be used to perform the same tasks as the airborne robot 14 discussed above and outlined in FIG. 2, namely where the wheeled robots 12 may be sent to a waiting room to call or retrieve a specified patient and then escort them to a separate designated location within the same office, and/or transport items or objects between locations as requested by either the office workers or the control point or server 16 or according to a pre-existing schedule or time table as outlined in FIG. 3.

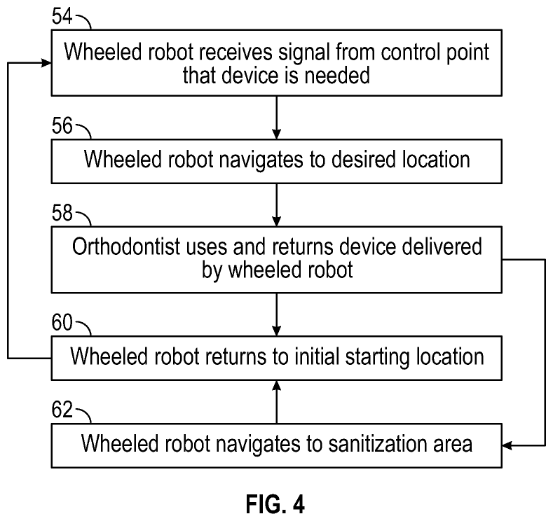

In a related embodiment seen in FIG. 4, the wheeled robots 12 of the office management system 10 may be specifically used to transport items or tools which are either too heavy or cumbersome for an airborne robot 14 to lift or which may otherwise be too expensive or valuable to transport by air should the item fall or prematurely detach from an airborne robot 14. In one example, each of the wheeled robots 12 may be specifically configured to transport dental or orthodontic tools such as an intraoral dental scanner between different examination rooms or chairs. In this embodiment, the intraoral dental scanner is coupled to or inserted into a cradle or seating which is in turn coupled or affixed to a base portion of each wheeled robot 12. When an intraoral scanner is required at a specific location within the office, a signal in step 54 is sent to the wheeled robot 12 which comprises the intraoral scanner which then moves toward to the selected location in step 56 using its suite of sensors and internal mapping software as discussed above. Once arrived, the wheeled robot 12 orientates itself so that the dental assistant or orthodontist may access the intraoral scanner and remove it from the cradle or seating disposed on the wheeled robot 12. In step 58, the dental professional performs the intraoral scan on the patient and then returns it to the cradle or seating. The wheeled robot 12 may then return to its initial starting location to await further requests in step 60, or alternatively in step 62, may sanitize the intraoral scanner by navigating over to a separate, dedicated sanitization station where the intraoral scanner may be properly cleaned and sanitized by either a human operator or another robotic sanitization means. In one particular embodiment, the separate robotic sanitization means may be the system and method for automated sterilization of dental, orthodontic, or medical instruments disclosed within U.S. Provisional Application 63/151,155, filed on Feb. 19, 2021, which is herein incorporated by reference in its entirety. After the cleaning and sanitization process is complete, the wheeled robot 12 may return to an initial starting point or location to then await subsequent further instructions from the control point or server 16.

In one particular embodiment, the intraoral scanner may be charged whenever it is inserted into the cradle or seating disposed on the wheeled robot 12. Charging of the intraoral scanner may occur whenever the wheeled robot 12 itself is being charged, for example when installed or placed into a charging station or when plugged directly into a wall outlet, or alternatively whenever the intraoral scanner is inserted into its cradle which may be connected to either its own dedicated recharging battery disposed on the wheeled robot 12 or to the wheeled robot's 12 own internal battery.

In another particular embodiment, the wheeled robot 12 may comprise an aperture or universal coupling point which serves as a means for removably or temporarily coupling the intraoral scanner's cradle or seating to the base portion of the wheeled robot 12. In this manner, each wheeled robot 12 may be able to support or mate with different types or brands of intraoral scanners, each of which may comprise a slightly different cradle or seating element. In other words, the aperture or universal coupling point will allow any office to use any type of intraoral scanner, thereby letting the office use any preexisting intraoral scanners they may already possess and avoid the need to purchase any new intraoral scanners in order to use wheeled robots 12 of the current office management system 10. Additionally, if a change in the type of intraoral scanners is needed, the office staff may simply remove the cradle or seating of the original intraoral scanner and then couple the cradle or seating for the new intraoral scanner without having to significantly modify the wheeled robot 12 itself.

With the control point or server 16 serving as the main data and communication hub for the robotic office management system 10, the plurality of robots 12, 14 or different sub-pluralities thereof may be configured and managed so as to carry out multiple different tasks in the office in which they are deployed without significant input from a human operator or user, thereby freeing those individuals up to perform more critical or labor-intensive tasks. The control point or server 16 ensures that all of the robots 12, 14 cooperate to form a cohesive network with each robot 12, 14 being tasked to perform one or more specific tasks or operations. The control point or server 16 may have a running list or schedule of tasks which may be populated automatically via a corresponding software program and/or by a human operator who enters or adds a specific task manually via input through their respective smart device 20 or user computer or terminal 18. When one or more of the robots 12, 14 completes a task, the control point or server 16 removes it from the running list or schedule. The next available or free robot 12, 14 is then assigned to the next task or job within the list or schedule. In a related embodiment, the control point or server 16 may designate or reserve certain tasks for certain ones of the plurality of robots. For example, certain tasks may be reserved or set aside for the airborne robots 14 while other tasks, such those requiring transporting of heavier or more cumbersome items, may be designated for the wheeled robots 12.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A method for managing an office using a network of robotic elements, the method comprising:
transmitting a first signal corresponding to a request to at least one robotic element within the network of robotic elements, wherein the request comprises a first location and a first task to be completed at the first location;
navigating to the first location associated with the request by the at least one robotic element;
performing the first task associated with the request by the at least one robotic element; and
transmitting a second signal corresponding to the request by the at least one robotic element to the network of robotic elements, wherein the second signal corresponding to the request comprises a notification that the first task has been performed.

2. The method of claim 1 wherein transmitting the first signal corresponding to the request to at least one robotic element within the network of robotic elements comprises transmitting the first signal corresponding to the request from a control point wirelessly connected to the at least one robotic element within the network of robotic elements.

3. The method of claim 2 further comprising initiating the first request at a computer or smart device and transmitting the initiated first request from the computer or smart device to the control point.

4. The method of claim 1 wherein transmitting the first signal corresponding to the request to at least one robotic element within the network of robotic elements comprises:
transmitting the first signal corresponding to the request to at least one airborne robotic element within the network of robotic elements; or
transmitting the first signal corresponding to the request to at least one wheeled robotic element within the network of robotic elements.

5. The method of claim 1 wherein performing the first task associated with the request by the at least one robotic element comprises:
scanning a first individual within the office by the at least one robotic element;
determining if the scanned first individual matches a preexisting credential associated with a patient;
scanning a second individual within the office by the at least one robotic element if the scanned first individual does not match the preexisting credential associated with the patient; or
escorting the scanned first individual to a second location if the scanned first individual does match the preexisting credential associated with the patient.

6. The method of claim 5 wherein scanning the first individual within the office by the at least one robotic element comprises performing a facial recognition scan of the first individual by the at least one robotic element, and wherein determining if the scanned first individual matches the preexisting credential associated with the patient comprises matching a face of the scanned first individual with a preexisting image of the patient.

7. The method of claim 5 wherein scanning the first individual within the office by the at least one robotic element comprises performing a scan of an RFID chip disposed on the first individual by the at least one robotic element, and wherein determining if the scanned first individual matches the preexisting credential associated with the patient comprises matching a reading from the RFID chip disposed on the scanned first individual with a preexisting ID associated with the patient.

8. The method of claim 5 wherein escorting the scanned first individual to the second location if the scanned first individual does match the preexisting credential associated with the patient comprises confirming that the first individual is the same as the patient by the at least one robotic element.

9. The method of claim 1 wherein performing the first task associated with the request by the at least one robotic element comprises:
acquiring an item associated with the request at the first location by the at least one robotic element;
navigating to a second location associated with the request by the at least one robotic element; and
delivering the item at the second location by the at least one robotic element.

10. The method of claim 9 wherein acquiring the item associated with the request at the first location comprises:
picking up the item by the at least one robotic element at the first location; or
coupling the item to the at least one robotic element by a user at the first location.

11. The method of claim 9 further comprising:
returning to the first location by the at least one robotic element if a second signal corresponding to the request is transmitted to the at least one robotic element; or
navigating to a charging station by the at least one robotic element if no second signal corresponding to the request is transmitted to the at least one robotic element.

12. The method of claim 1 wherein performing the first task associated with the request by the at least one robotic element comprises:
providing a user with an item disposed on the at least one robotic element;
remaining at the first location by the at least one robotic element until the user has returned the item to the at least one robotic element; and
exiting the first location by the at least one robotic element.

13. The method of claim 12 further comprising:
returning to the first location by the at least one robotic element; or
navigating to a sanitization station by the at least one robotic element.

14. A method for managing an office using a network of robotic elements, the method comprising:
transmitting a first signal corresponding to a first request to a first plurality of robotic elements within the network of robotic elements, wherein the first request comprises a first location and a first task to be completed at the first location;
transmitting a second signal corresponding to a second request to a second plurality of robotic elements within the network of robotic elements, wherein the second request comprises a second location and a second task to be completed at the second location;
navigating to the first location associated with the first request by at least one of the first plurality of robotic elements;
navigating to the second location associated with the second request by at least one of the second plurality of robotic elements;
performing the first task associated with the first request by the at least one of the first plurality of robotic elements; and
performing the second task associated with the second request by the at least one of the second plurality of robotic elements.

15. The method of claim 14 wherein transmitting the first signal corresponding to the first request to the first plurality of robotic elements within the network of robotic elements and transmitting the second signal corresponding to the second request to the second plurality of robotic elements within the network of robotic elements each comprises transmitting the first and second signals corresponding to the first and second requests from a control point wirelessly connected to the first and second plurality of robotic elements.

16. The method of claim 15 further comprising initiating the first and second request at a computer or smart device and transmitting the initiated first and second request from the computer or smart device to the control point.

17. The method of claim 14 wherein transmitting the first signal corresponding to the first request to the first plurality of robotic elements within the network of robotic elements and transmitting the second signal corresponding to the second request to the second plurality of robotic elements within the network of robotic elements comprises:
transmitting the first signal corresponding to the first request to at least one airborne robotic element within the first plurality of robotic elements; and
transmitting the second signal corresponding to the second request to at least one wheeled robotic element within the second plurality of robotic elements.

18. The method of claim 15 wherein initiating the first and second request at a computer or smart device further comprises initiating a list comprising a plurality of tasks to be performed by the first and second plurality of robotic elements.
